(19) United States
(12) Patent Application Publication
(10) Pub. No.: US 2026/0161797 A1
(43) Pub. Date: Jun. 11, 2026

(54) PARAMETER DETERMINATION FOR SECURITY TESTING

(71) Applicant: International Business Machines Corporation, Armonk, NY (US)

(72) Inventors: Michael Page KASPER, Wappingers Falls, NY (US); Andrew Christian Morrell HICKS, Highland, NY (US); Joshua David STEEN, Fishkill, NY (US); Diane Marie STAMBONI, Poughkeepsie, NY (US); Christopher Vincent DEROBERTIS, Hopewell Junction, NY (US)

(21) Appl. No.: 18/977,433

(22) Filed: Dec. 11, 2024

(51) Int. Cl. G06F 21/57; G06F 11/34

(52) U.S. Cl. CPC G06F 21/577; G06F 11/3476

(57) ABSTRACT

A computer system obtains system diagnostic data corresponding to data events associated with an authorized system component of an operating system. Based on the system diagnostic data, at least one parameter format associated with the authorized system component is determined. A security test is configured based on the determined parameter format. The security test is then performed in association with the authorized system component.

### BACKGROUND

The present invention relates to computer systems, and for example, relates to parameter determination for security testing.

### SUMMARY

In some implementations, a computer system includes a processor set, one or more computer-readable storage media, and program instructions stored on the one or more computer-readable storage media. The program instructions may be configured to cause the processor set to perform operations including obtaining system diagnostic data corresponding to data events associated with an authorized system component of an operating system, determining, based on the system diagnostic data, at least one parameter format associated with the authorized system component, configuring a security test based on the at least one parameter format, and performing the security test in association with the authorized system component.

In some implementations, a computer-implemented method includes obtaining system diagnostic data corresponding to data events associated with an authorized system component of an operating system, determining, based on the system diagnostic data, at least one parameter format associated with the authorized system component, configuring a security test based on the at least one parameter format, and performing the security test in association with the authorized service.

In some implementations, a computer program product includes one or more computer-readable storage media and program instructions stored on the one or more computer-readable storage media for performing operations. The operations include obtaining system diagnostic data corresponding to data events associated with an authorized system component of an operating system, determining, based on the system diagnostic data, at least one parameter format associated with the authorized system component, configuring a security test based on the at least one parameter format, and performing the security test in association with the authorized service.

### BRIEF DESCRIPTION OF THE DRAWINGS

FIG. 1 is a diagram of an example system described herein.

FIGS. 2A and 2B are diagrams showing example implementations of parameter determination for security testing described herein.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with parameter determination for security testing.

### DETAILED DESCRIPTION

The following detailed description of example implementations refers to the accompanying drawings. The same reference numbers in different drawings may identify the same or similar elements.

In a computer system, the kernel serves as the core component of the operating system, managing essential functions such as process execution, device control, and interrupt handling, among other tasks. Some of these operations are performed in response to system calls from various processes, while others occur in response to specific system conditions and internal management logic. The kernel has full access to the computer's memory system and is responsible for managing and provisioning memory for both user processes and operating system processes. It can implement virtual addressing by organizing memory into pages, which allows larger segments or frames of memory to appear contiguous to processes, even when the physical memory addresses are non-contiguous.

Within mainframe operating systems (and, in many cases, other types of operating systems), services may be categorized as either “authorized” or “unauthorized,” depending on the level of privilege they require to execute specific system-level operations. Authorized services may be services that are granted elevated access rights, enabling them to perform operations that could otherwise compromise system integrity or security if misused. These services generally have access to sensitive system features, such as the Supervisor State or the Authorized Program Facility (APF) libraries and AC(1) setting, and may be empowered to execute privileged instructions that directly interact with the system's kernel or hardware. Authorized services may perform any number of different functions, such as memory management, input/output control, and inter-process communication, which require elevated access to ensure efficient system operation. Unauthorized services, conversely, may be restricted from performing these privileged operations and may operate within a more confined security boundary, ensuring that they cannot unintentionally or maliciously affect other processes or the system as a whole.

Similarly, authorized programs may be executable applications or utilities that have been granted elevated privileges to access specific authorized services. These programs may be designated as “authorized” by residing within a designated APF-authorized library or by having specific attributes set, such as execution in Supervisor State or with key zero privileges, which allows them direct access to system resources. Examples of authorized programs include system utilities and diagnostics tools that require access to hardware registers, storage key manipulation, or privileged input/output instructions. These programs may facilitate system maintenance, troubleshooting, and resource management.

Unauthorized programs may lack the necessary privileges to access the functions provided by authorized services or perform privileged operations. These programs may run in User State, with restricted access to certain memory areas and system resources, ensuring that they operate within secure boundaries. Unauthorized programs may interact with the system through controlled interfaces and APIs but may be prevented from executing any operations that could compromise system security or stability. By operating unauthorized programs within such limitations, some operating systems may maintain a secure environment where applications with lesser security requirements cannot inadvertently interfere with critical system operations or access sensitive data.

To maintain the integrity of authorized programs and services, regular security testing may be performed. Security testing of authorized programs and services may ensure that any vulnerabilities or potential security weaknesses are identified and addressed before they can be exploited. Given that authorized programs have elevated privileges, any flaws in their design or implementation could expose the system to significant risks, including unauthorized access to sensitive data, privilege escalation, and system stability issues. Regular testing may be conducted using a variety of methods, including static code analysis, penetration testing, and runtime behavior analysis, to confirm that authorized programs and services adhere to best security practices and do not unintentionally create avenues for security breaches.

Authorized system components, including authorized services and authorized programs, may enable unauthorized programs to perform certain privileged functions. However, unauthorized programs can invoke these components in unintended ways, potentially leading to situations where integrity checks within the authorized component may be bypassed, thereby compromising system confidentiality, integrity, or availability.

Testing the security of authorized programs and services may serve to reinforce the trust boundary that separates authorized components from unauthorized ones within operating system environments. This testing process ensures that authorized programs only perform designated operations without inadvertently granting unauthorized programs or users elevated access. By rigorously validating the security of authorized programs, administrators can maintain the reliability of the environment, ensure compliance with security standards, and reduce the risk of internal or external security threats. Given the nature of the services provided by authorized programs, such testing may facilitate upholding the system's overall security and prevent operational disruptions or data integrity issues.

To effectively test these components, testing tools may determine appropriate input data that will adequately exercise the functionality of the authorized system component. Random data, while easy to generate, often fails to exercise a significant portion of the code within the component, as it does not account for the structure and specific requirements of parameter lists. Consequently, random inputs may frequently result in early rejection due to invalid parameters, thereby bypassing important areas of the code. For instance, parameter lists often include memory addresses or lists of addresses, and the length of these addresses can be defined by the addressing mode currently in use.

Test operations may be designed to intentionally trigger protection exceptions upon access to specific memory locations. For cybersecurity testing, this can involve calling an authorized system component to verify if it interacts with particular system registers or memory locations. This process may entail gathering information about the target of the test (e.g., an authorized system service), identifying possible parameter structures, and attempting to exploit these structures to assess the system's resilience. However, the extensive range of possible parameter configurations often results in a vast number of tests, each with unique permutations that must be evaluated.

In cybersecurity testing, one attack vector may involve using a parameter list that points to various protected memory regions (e.g., key 0, write-protected storage, or fetch-protected storage). This approach enables the testing process to verify whether the authorized system component interacts with designated registers or protected memory areas. Due to the substantial number of possible parameter combinations, these tests can expand rapidly as the number of parameters increases, often growing at an exponential rate.

Example embodiments of the invention relate to, among other things, devices, systems, methods, computer-readable media, techniques, and methodologies for assigning test case priorities for testing performed on a system under test (SUT), also referred to as a target system, through test case generation. The SUT may be a hardware system or a software system. The SUT may or may not be the same system where data is collected although it may have similar services available to allow the collected data from one system to be used for testing another.

Authorized system components, which operate with elevated privileges, are essential for system operation but can introduce potential vulnerabilities if not adequately secured. The complexity of these components, combined with limited or incomplete documentation of their interfaces, presents a significant challenge for security testing. Security professionals often lack comprehensive knowledge of valid parameter formats for these components, increasing the risk of overlooking potential vulnerabilities due to incomplete test coverage.

Traditional approaches to security testing of authorized services often rely on random data input or manual analysis, both of which have significant limitations. Random testing often leads to repetitive failure conditions without thoroughly exploring all possible code paths within the component. Consequently, this approach may fail to uncover subtle vulnerabilities that only appear under specific input conditions. Manual analysis, although potentially more thorough, is time-consuming, prone to human error, and often impractical given the large number of authorized components within complex operating systems such as z/OS. Additionally, the lack of insight into the internal functioning of these components further complicates the development of effective test cases.

Implementations described herein are directed to a system and method for dynamic parameter discovery and security testing of authorized services in computer systems. The system obtains system diagnostic data corresponding to data events associated with an authorized system component of an operating system. As used herein, the term “authorized system component” refers to any privileged program, service, or code module that operates with authorization and/or elevated access rights within the operating system, including but not limited to kernel services, system utilities, authorized services, and authorized programs. The system diagnostic data may include system dump data, system log entry data, logrec records, system call traces, and system register status traces. In some implementations, the system call traces are obtained from a general trace facility (GTF) and/or through system log interface program (SLIP) traps.

Implementations described herein determine at least one parameter format associated with the authorized system component based on the obtained system diagnostic data. This determination involves analyzing the collected data to extract meaningful information about the service's parameter structure. The term “parameter format” encompasses various characteristics of input parameters, including data types, valid ranges, and structural relationships. The system obtains a set of values for a parameter associated with the authorized system component and classifies the parameter into one of several parameter types based on the observed values. For example, a parameter may be classified as a constant value if its set of values remains unchanged across multiple observations. Alternatively, it may be classified as a function code if there is a variance in the set of values associated with a specific value range, or as a bit flag if the set of values comprises a predefined set of bit flag values. In cases where there is a variance in the set of values and the values include pointer information, or fit the known patterns for pointer values, the parameter may be classified as a pointer.

Implementations described herein configure a security test based on the determined parameter format. This configuration process leverages the discovered parameter information to generate more targeted and effective test cases. The term “security test” refers to any procedure or set of procedures designed to identify potential vulnerabilities or weaknesses in the authorized system component. These tests may include, but are not limited to, boundary value analysis, fuzz testing, and penetration testing techniques. By tailoring the security tests to the specific parameter formats identified, the system can more effectively probe the authorized service for potential security flaws.

Implementations described herein perform the configured security test in association with the authorized system component. This testing process involves executing the prepared test cases and analyzing the results to identify any potential vulnerabilities. These results may include any program checks or errors generated as a result which can be examined to discover vulnerabilities. The term “performing” in this context may include actions such as initiating system calls, manipulating input parameters, and monitoring system responses. In some implementations, the security testing process may be initiated through a supervisor call, which triggers a system call to the authorized service. The system then records the resulting diagnostic data, providing a comprehensive view of the service's behavior under various test conditions. This approach allows for thorough security testing while maintaining the integrity of the system, as the tests are conducted within the controlled environment of the authorized service's normal operation. In addition, data collected from a production system could be used to test the same authorized services on a test system, in order to avoid the risk of disrupting work on the production system.

In some implementations, the system obtains system diagnostic data corresponding to data events associated with an authorized system component of an operating system. Accordingly, an advantage of obtaining system diagnostic data is that it provides a non-intrusive way to gather information about authorized services without requiring modifications to the services or impacting production workloads. Additionally, an advantage of obtaining system diagnostic data is that it allows for comprehensive data collection across multiple authorized services simultaneously, enabling efficient analysis of parameter formats for numerous components.

In some implementations, the system determines at least one parameter format associated with the authorized system component based on the obtained system diagnostic data. Accordingly, an advantage of determining parameter formats is that it enables more targeted and effective security testing by providing insight into the expected structure and constraints of input parameters. Additionally, an advantage of determining parameter formats is that it reduces the time and expertise required to develop effective security tests for authorized services, as the system can automatically infer parameter characteristics without relying on detailed API documentation.

In some implementations, the system configures and performs a security test based on the determined parameter format. Accordingly, an advantage of configuring and performing security tests based on determined parameter formats is that it allows for more thorough and efficient vulnerability scanning by generating test cases that are tailored to the specific characteristics of each authorized service. Additionally, an advantage of configuring and performing security tests based on determined parameter formats is that it enables the discovery of potential vulnerabilities that may be missed by random fuzzing approaches, as the tests can probe specific boundary conditions and edge cases based on the inferred parameter structures.

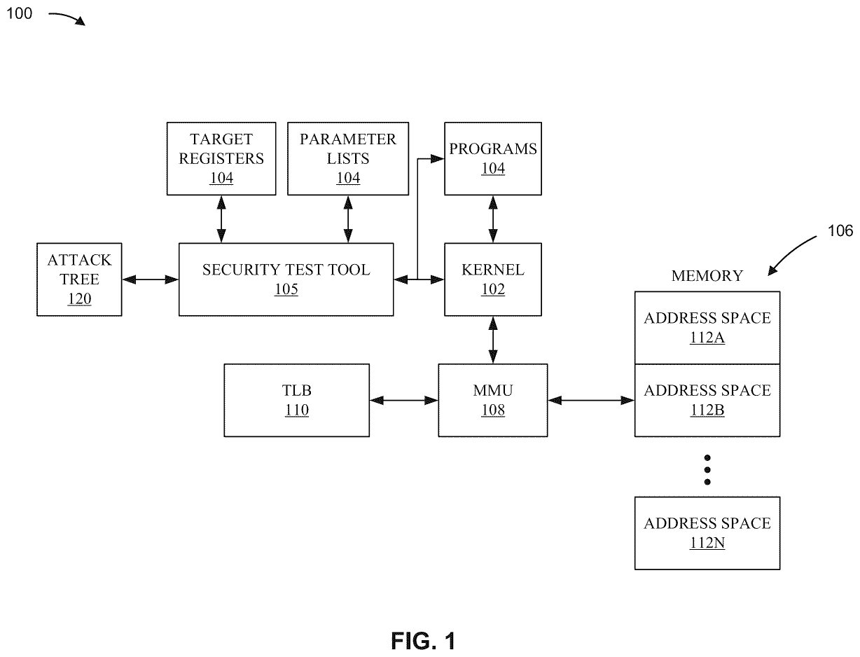

FIG. 1 depicts a block diagram of an example of a computer system 100. The computer system 100 can include a kernel 102 of an operating system (OS). The kernel 102 can enable provisioning of resources of the computer system 100 to support execution of a plurality of programs 104. The kernel 102 may execute directly on a processing system or as part of a virtual machine when supported by a hypervisor, for example. The kernel 102 can access memory 106 through a memory management unit 108. The memory management unit 108 can divide the memory 106 into a plurality of pages addressed through virtual memory addressing. The memory management unit 108 can use a translation lookaside buffer 110 or other structure to support mapping of virtual page addresses to actual (e.g., physical or effective) page addresses in the memory 106. The memory 106 may be subdivided into a plurality of address spaces, such as address space 112A, address space 112B, and address space 112N that each have different access permissions. For example, some programs 104 may normally be limited to accessing the address space 112A, while the other programs 104 may normally be limited to accessing the address space 112B. Where address space switching is supported, one of the programs 104 of address space 112A may call one of the programs 104 of address space 112B, where access constraints are expected to limit permissions of the program 104 of address space 112A in address space 112B.

A security test tool 105 can be executed that tests for security vulnerabilities related to access constraints and other security concerns. The security test tool 105 can access an attack tree 120 to test one or more authorized services of the kernel 102 and/or programs 104, for instance, to identify potential vulnerability to a cyber-attack. The attack tree 120 can define test cases based on test vectors in coordination with one or more parameter lists 122 and target registers 124. The attack tree 120 can include attack tree data that defines a plurality of data parameter sets and links between data parameter sets as sequences for the parameter lists 122 and/or target registers 124.

In example embodiments, the security test tool 105 can use a discovery process to determine which registers of the target registers 124 point to parameter data, such as parameter lists 122. By obtaining a pointer to a first protected storage location of the memory 106 that will cause a protection exception when read or overwritten, and setting a target register 124 to point to the first protected storage location, address effects can be isolated from other target registers 124 that do not point to the first protected storage location. Instead, the other target registers 124 can be initialized to contain expected constant values or pointers to data that does not cause a protection exception. If no protection exception occurs, the contents of the target register 124 or data at locations pointed to by the target register 124 can be modified. Further, the other target registers 124 or data pointed to by the other target registers 124 can be modified. If a sufficient number of possible values are exhausted but no protection exception has occurred, it is likely that the target register 124 does not contain a pointer to an address being used as a parameter by an authorized service. After testing every one of the target registers 124 this way, the security test tool 105 can identify a list of the target registers 124 used as input to the authorized service.

If the security test tool 105 discovers that a target register 124 holds a parameter address because a protection exception occurred for the address supplied in the target register 124, then the security test tool 105 can seek to determine parameter characteristics. For example, in 64-bit addressing mode, the security test tool 105 can obtain 200 bytes of storage, enough for 25 parameters of 8 bytes each. Leaving the values of the other target registers 124 constant at first, or possibly varying them later, the security test tool 105 can set all 25 parameters (e.g., of parameter list 122) to either contain constant values or pointers to valid storage, such as parameter areas in memory 106. One-by-one, the security test tool 105 can set one 8-byte parameter at a time to point to a second protected storage location that will cause a protection exception. When a protection exception occurs at an address after calling the authorized service with the parameter list 122, the security test tool 105 can confirm identification of a parameter address in the parameter list 122 pointed to by the target register 124. Going through all of the parameter lists 122, one parameter at a time, the security test tool 105 can build a list or map of which parameters contain addresses. In 32, 31, or 24-bit addressing mode, 4-byte parameters could be used instead, for example.

Once a list of parameters is found that contains addresses or additional parameters, the security test tool 105 can map constraints of the parameter lists 122 and target registers 124 to construct a testing profile of discovered relationships and extend testing of the authorized service to additional levels of parameters. Since a large number of permutations is possible as parameter variations are explored, the security test tool 105 can apply a reduction process to reduce complexity of the attack tree 120.

In some implementations, generating the list of parameters may include determining parameter formats, as described herein. To determine parameter formats, the computer system 100 may obtain system diagnostic data corresponding to data events associated with an authorized system component of an operating system. The security test tool 105 may initiate this process by configuring the kernel 102 to capture relevant diagnostic information. This may involve setting up trace points or hooks within the kernel 102 to monitor specific system calls, memory accesses, or other relevant events associated with the authorized system component. The process of obtaining system diagnostic data, determining parameter formats, and configuring and performing security tests works through a series of interconnected steps designed to enhance the security testing of authorized system components.

The system diagnostic data may be collected through various mechanisms implemented within the computer system 100. For example, the security test tool 105 may utilize the memory management unit 108 to track memory accesses and page faults related to the authorized system component. The translation lookaside buffer 110 may be monitored to gather information about address translations and memory access patterns. Additionally, the security test tool 105 may interact with the kernel 102 to capture system log entries, dump data, or other diagnostic information generated during the execution of the authorized system component.

Based on the obtained system diagnostic data, the security test tool 105 may determine at least one parameter format associated with the authorized system component. This process may involve analyzing the collected data to identify patterns, recurring values, or specific structures that indicate the format of input parameters. The security test tool 105 may examine memory access patterns, system call arguments, and other relevant information to infer the types, sizes, and relationships of parameters used by the authorized system component.

In some cases, the security test tool 105 may utilize the attack tree 120 to guide the parameter format determination process. The attack tree 120 may contain predefined patterns or heuristics that help identify common parameter structures used in authorized system components. By comparing the obtained diagnostic data against these patterns, the security test tool 105 may more efficiently determine the parameter formats.

Once the parameter formats are determined, the security test tool 105 may configure a security test based on this information. This configuration process may involve generating test cases that specifically target the identified parameter formats. For example, if a parameter is determined to be a pointer, the security test tool 105 may generate test cases that manipulate pointer values to probe for potential vulnerabilities such as buffer overflows or use-after-free conditions.

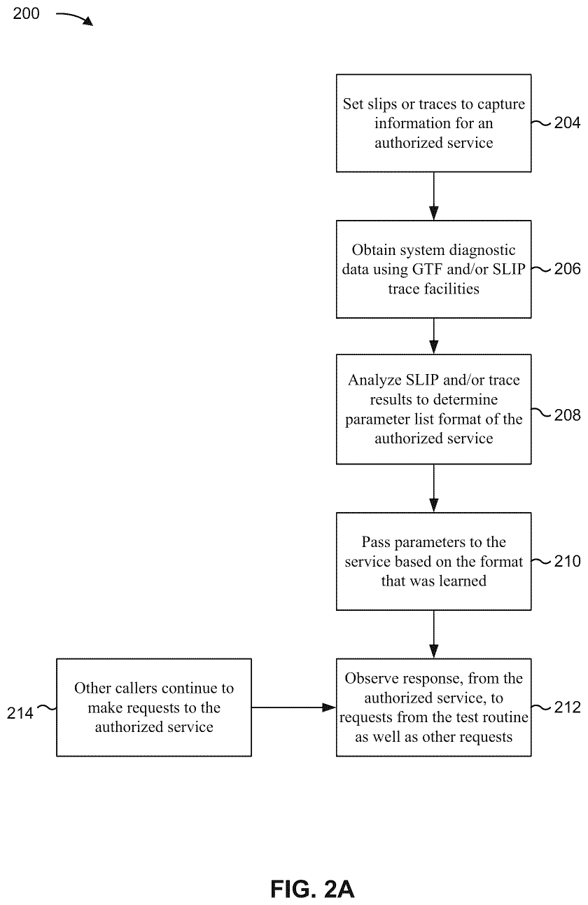

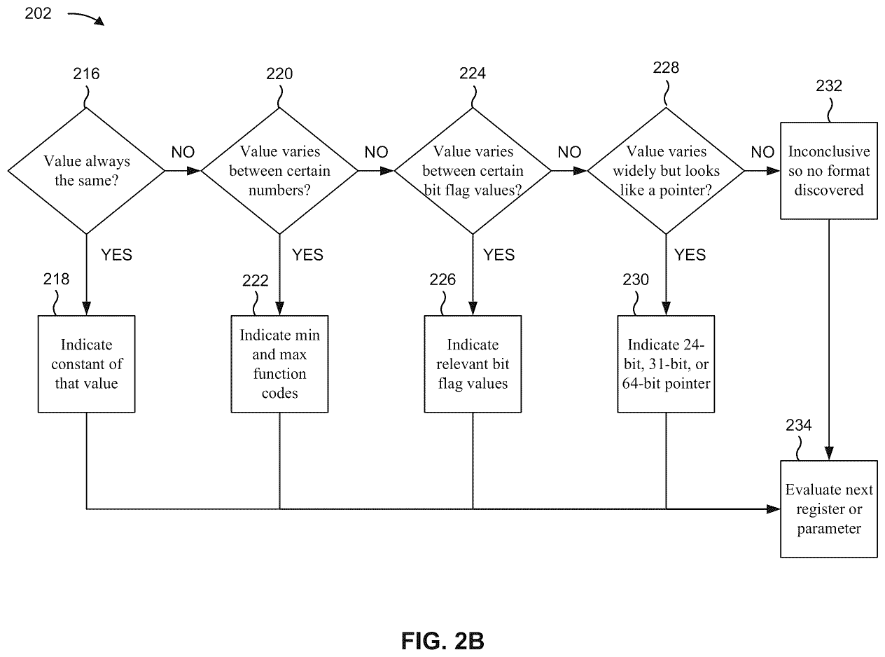

The security test tool 105 may utilize parameter lists and target registers to construct the test cases. By populating these structures with values that conform to the determined parameter formats, the security test tool 105 can create targeted tests that are more likely to exercise specific code paths within the authorized system component. This approach may allow for more thorough testing compared to random or generic fuzzing techniques. Other parameter format determination techniques are described below in connection with FIGS. 2A and 2B.

To perform the configured security test, the security test tool 105 may interact with the kernel 102 to execute the authorized system component with the prepared test cases. This may involve making system calls, manipulating memory contents, or otherwise invoking the authorized system component in a controlled manner. The security test tool 105 may monitor the execution, capturing any exceptions, unexpected behaviors, or other indicators of potential vulnerabilities.

Throughout the testing process, the security test tool 105 may continuously analyze the results and refine its testing approach. For example, if a particular parameter combination triggers an interesting behavior, the security test tool 105 may generate additional test cases to further explore that area. This adaptive testing approach, guided by the determined parameter formats, may allow for more efficient and effective security testing of the authorized system component.

As a specific example, consider testing an authorized system component that manages user authentication. The security test tool 105 may first obtain system diagnostic data by monitoring system calls related to user login attempts. By analyzing this data, the security test tool 105 may determine that the component accepts parameters for username (a string), password (a string), and authentication method (an integer flag). Based on this information, the security test tool 105 could configure tests that include valid and invalid usernames of various lengths, password strings with special characters, and different authentication method flags. During testing, the security test tool 105 may discover that certain long username inputs cause unexpected behavior, potentially indicating a buffer overflow vulnerability that requires further investigation.

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

FIGS. 2A and 2B are diagrams showing example implementations 200 and 202 of parameter determination for security testing described herein. The implementation 200 and/or the implementation 202 may be, be similar to, include, or be included in the computer system 100 shown in FIG. 1.

FIG. 2A illustrates a flowchart of an exemplary process 200 for dynamic parameter discovery and security testing of authorized services. The process 200 begins with step 204, where a targeting routine sets slips or traces to capture information for a service. This step initiates the data collection process that may be useful for understanding the behavior and parameters of authorized system components. The targeting routine may utilize various mechanisms to set up the capture of relevant information, such as configuring system trace facilities or establishing specific monitoring points within the system.

In some implementations, as shown at 206, the process 200 includes obtaining system diagnostic data using generalized trace facility (GTF) and/or system log interface program (SLIP) trace facilities. Such facilities may be employed to collect detailed system diagnostic data related to the targeted service.

A trace facility in the context of an operating system refers to a diagnostic tool or set of tools that monitor and record specific events, operations, and system activities, providing valuable insight into system performance and issues. The trace facility enables system administrators and developers to observe how processes are executing, identify performance bottlenecks, and troubleshoot errors within complex operational environments. By systematically recording activities, trace facilities allow for detailed analysis post-execution, which can be instrumental in pinpointing errors, debugging system behaviors, or ensuring that certain processes meet performance benchmarks. Terms commonly associated with trace facilities include “event tracing,” which refers to the tracking of specific system or application events, and “system trace,” which indicates a broader tracking of core system-level operations. In some implementations, trace facilities may be configured to maintain the reliability, availability, and serviceability (RAS) of the system.

The GTF is a versatile trace tool that captures a wide range of system events and activities. The GTF can be configured to trace particular events, such as input/output operations, system interrupts, and task-related events, making it highly adaptable to different tracing requirements. The GTF's output may be recorded in a trace dataset, allowing detailed examination after tracing is complete. By providing insights into various low-level system processes, the GTF helps system administrators and developers to diagnose and resolve issues with I/O operations, performance anomalies, and even security-related events.

The SLIP facility may be configured to provide a more targeted approach to tracing specific conditions and error states within the system. SLIP operates by setting “SLIP traps” - conditions defined by the user that, when met, trigger the recording of trace information or initiate an action, such as generating a system dump. SLIP traps may be configured to capture specific error conditions, such as certain types of abends (abnormal ends of a process) or storage violations, allowing system administrators to pinpoint the cause of these anomalies with high precision. When a SLIP trap is triggered, the resulting data can be collected immediately or stored in a predefined dataset for later analysis. A SLIP trap facility may be useful, for example, in production environments, where minimal disruption is critical, as it enables targeted diagnostics without requiring system-wide tracing, thus limiting the performance impact on the overall system.

For example, the GTF may provide a versatile tracing mechanism that can capture a wide range of system events, including I/O operations, program calls, and system state changes. SLIP may offer a more targeted approach, allowing for the capture of specific system conditions or error states. Together, these facilities may enable comprehensive data collection that can be used to form the foundation for subsequent analysis and testing.

In step 208, an analysis routine analyzes the SLIP and/or trace results to determine the parameter list format of the authorized service. This step may include processing the collected data to extract meaningful information about the service's parameter structure. The analysis routine may employ various algorithms and heuristics to identify patterns in the data, such as recurring values, address ranges, or specific bit configurations. This analysis may be valuable for understanding the expected input format of the authorized service, which can be useful for effective security testing.

At 210, the process 200 includes passing parameters to the service based on the format that was learned from the analysis. This step utilizes the information gathered and analyzed in previous steps to generate test cases. The dynamic testing routine may employ various strategies to construct parameter lists, such as using discovered constant values, exploring identified value ranges for function codes, or manipulating bit flags. This approach may allow for more targeted and effective testing compared to random input generation, as it takes into account the specific characteristics of the service's parameter format.

At 212, the security test tool observes responses from the authorized service in response to requests from the test routine, as well as other requests, which may be made, as indicated at 214. In this way, some implementations may be useful for identifying potential vulnerabilities that may only manifest under specific conditions or in interaction with other system components. Testing while other callers make requests to the authorized service may enable testing under realistic load conditions, helping to identify potential race conditions or timing-related vulnerabilities, and ensuring that the testing process does not disrupt critical system functions.

The results of the security test may be analyzed (e.g., by the security test tool 105 shown in FIG. 1) and an action may be performed based on the analysis of the security test results. The action may include, for example, reporting the results, issuing a security alert based on the results, and/or generating a vulnerability report based on the results, among other examples.

Implementations of the process 200 may provide several advantages over traditional security testing approaches. By dynamically discovering parameter formats, some implementations may enable more thorough testing of authorized services without relying on comprehensive API documentation. This can be valuable for legacy systems or third-party components where detailed interface specifications may not be available. Additionally, some implementations may allow for continuous adaptation to changes in service interfaces, helping to ensure that security testing remains effective as the system evolves.

FIG. 2B illustrates a flowchart for a process 202 of analyzing parameter values in a system. The process 202 begins with a step 216, which includes determining if a parameter value is always the same. This step may be useful for identifying constant parameters, which are often used for flags, version numbers, or other fixed identifiers in service calls. If the value is constant, the process 202 moves to step 218, which includes indicating the constant value. Recognizing constant values may be important for constructing valid test cases and identifying potential areas where unexpected values might lead to security vulnerabilities.

If the value is not constant, the process 202 proceeds to step 220, which includes checking if the value varies between certain numbers. This step is designed to identify parameters that may represent function codes or enumerated types. Function codes often indicate specific operations or modes for a service, and understanding their valid range may be useful for comprehensive testing. If such a pattern is detected, the process 202 moves to step 222, which includes indicating the minimum and maximum function codes. This information allows the testing routine to systematically explore all possible function codes within the identified range.

If the value does not vary between certain numbers, the process 202 continues to step 224, which includes checking if the value varies between certain bit flag values. Bit flags are commonly used in system programming to represent multiple boolean options in a single parameter. If this is the case, the process 202 proceeds to step 226, which includes indicating the relevant bit flag values. Understanding the structure and meaning of bit flags may be useful for testing different combinations of options and identifying potential security issues related to unexpected flag combinations.

If the value does not match the bit flag pattern, the process 202 moves to step 228, which includes determining if the value vary widely but “look like a pointer” (e.g., have the characteristics of a pointer). Pointers are often used in system programming, typically to reference data structures or memory locations. Identifying pointer parameters may be important for security testing, as they can be potential vectors for attacks like buffer overflows or use-after-free vulnerabilities. If a pointer is detected, at 230, the process 202 includes indicating whether the pointer is 24-bit, 31-bit, or 64-bit. This classification may be useful for understanding the addressing mode and potential memory range that can be accessed through the pointer.

If none of the previous conditions are met, the process 202 proceeds to step 232, which includes indicating that the analysis is inconclusive and no format is discovered. This step may be important for handling edge cases or complex parameter types that do not fit into the predefined categories. Even when a parameter's format is not conclusively determined, this information may be valuable for the testing process, as it may indicate areas that require more in-depth manual analysis or specialized testing approaches.

At 234, the process 202 includes evaluating the next register or parameter. This iterative approach helps ensure that all parameters of the authorized service are analyzed, providing a comprehensive understanding of the service's interface.

The processes illustrated in FIGS. 2A and 2B may be configured to work together to provide a robust solution for security testing of authorized system components. By dynamically discovering and analyzing parameter formats, these processes may enable more effective and efficient security testing, particularly in environments where detailed API documentation may be lacking.

Some implementations may be configured to adapt to changes in service interfaces automatically. As systems evolve and new services are introduced, the dynamic discovery process can identify and analyze new parameter formats without requiring manual updates to the testing framework. This adaptability helps ensure that security testing remains effective over time, even as the underlying system changes. Some implementations may reduce manual effort required for security testing. By automating the process of parameter format discovery and analysis, security professionals can focus their efforts on interpreting test results and addressing identified vulnerabilities, rather than spending time manually constructing test cases or reverse-engineering service interfaces.

The processes described in FIGS. 2A and 2B can be implemented in various ways. For example, the targeting routine in step 204 may be configured to focus on specific high-risk services or to perform a broad scan of all authorized services in the system. The analysis routine in step 208 may employ machine learning algorithms to improve its accuracy in identifying parameter formats over time. The dynamic testing routine in step 210 may be integrated with existing vulnerability scanners or penetration testing tools to provide a more comprehensive security assessment.

Some implementations may include additional steps for correlating discovered vulnerabilities with specific parameter formats or combinations. This could help in identifying patterns of vulnerabilities across different services or system components. Some implementations may incorporate feedback loops, where the results of security tests are used to refine the parameter discovery and analysis processes, leading to increasingly targeted and effective testing over time. Any number of different implementations are contemplated within the ambit of the present disclosure.

As indicated above, FIGS. 2A and 2B are provided as an example. Other examples may differ from what is described with regard to FIGS. 2A and 2B. The number and arrangement of devices shown in FIGS. 2A and 2B are provided as an example. A network, formed by the devices shown in FIGS. 2A and 2B may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 2A and 2B. Furthermore, two or more devices shown in FIGS. 2A-2I may be implemented within a single device, or a single device shown in FIGS. 2A and 2B may be implemented as multiple, distributed devices. Additionally, or alternatively, a set of devices (e.g., one or more devices) shown in FIGS. 2A and 2B may perform one or more functions described as being performed by another set of devices shown in FIGS. 2A and 2B.

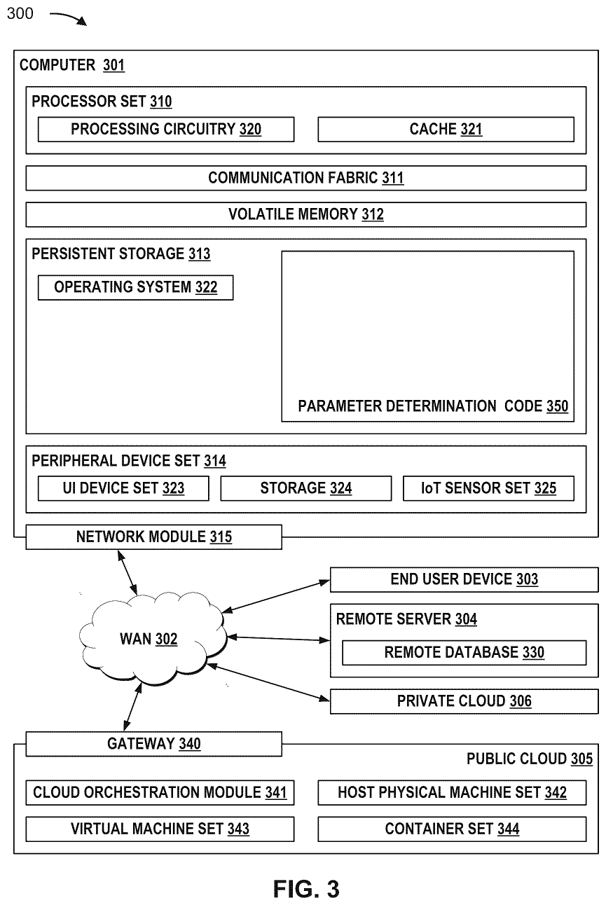

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as parameter determination code, included in block 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

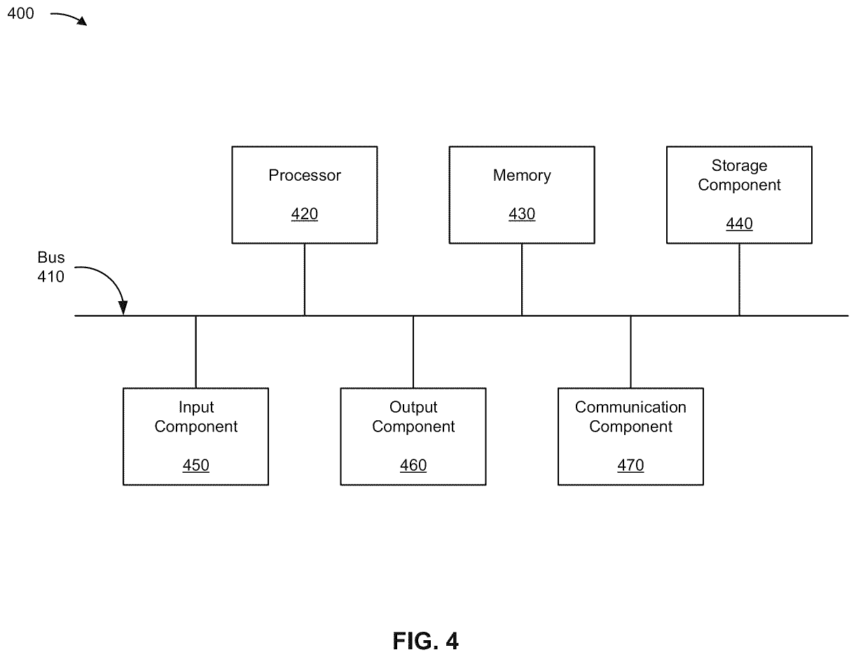

FIG. 4 is a diagram of example components of a device 400, which may correspond to a computer system 100. In some implementations, the security test tool 105 may include one or more devices of the computing environment 300 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

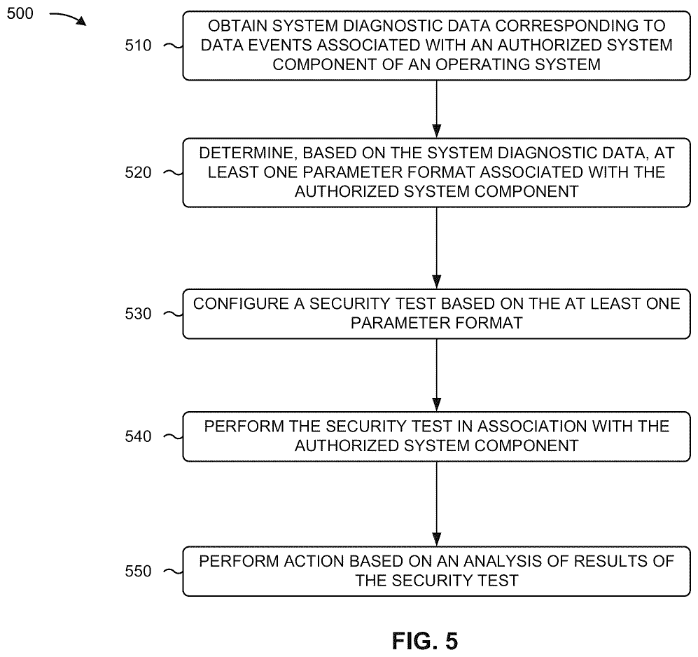

FIG. 5 is a flowchart of an example process 500 associated with parameter determination for security testing as described herein. In some implementations, one or more process blocks of FIG. 5 may be performed by a security test tool (e.g., security test tool 105). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include obtaining system diagnostic data corresponding to data events associated with an authorized system component of an operating system (block 510). For example, the security test tool may obtain system diagnostic data corresponding to data events associated with an authorized system component of an operating system, as described above. The authorized system component may include an authorized service and/or an authorized program, among other examples.

In some implementations, obtaining the system diagnostic data may include initiating, via a supervisor call, a system call and recording, in response to the system call, the system diagnostic data. In some implementations, the obtaining the system diagnostic data may include obtaining at least one of system dump data and system log entry data. In some implementations, obtaining the system diagnostic data may include obtaining system call traces. In some implementations, obtaining the system call traces may include obtaining call traces from a GTF. In some implementations, the obtaining the system call traces may include obtaining call traces from SLIP traps. In some implementations, obtaining the system diagnostic data may include obtaining system register status traces.

As further shown in FIG. 5, process 500 may include determining, based on the system diagnostic data, at least one parameter format associated with the authorized system component (block 520). For example, the security test tool may determine, based on the system diagnostic data, at least one parameter format associated with the authorized system component, as described above. In some implementations, determining the at least one parameter format associated with the authorized system component may include obtaining a set of values of a parameter associated with the authorized system component and classifying the parameter into one of a plurality of different parameter types based on the set of values.

For example, classifying the parameter may include classifying the parameter as a constant value based on the set of values being constant, classifying the parameter as a function code based on a variance in the set of values associated with a value range, classifying the parameter as a bit flag based on the set of values comprising a set of bit flag values, and/or classifying the parameter as a pointer based on a variance in the set of values and the set of values including pointer information.

As further shown in FIG. 5, process 500 may include configuring a security test based on the at least one parameter form (block 530). For example, the security test tool may configure a security test based on the at least one parameter form, as described above. As further shown in FIG. 5, process 500 may include performing the security test in association with the authorized system component (block 540). For example, the security test tool may perform the security test in association with the authorized system component, as described above. As further shown in FIG. 5, process 500 may include performing an action based on an analysis of results of the security test (block 550). For example, the security test tool may perform an action based on an analysis of results of the security test, as described above.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

According to an aspect of the disclosure, there is provided a computer system. The computer system includes a processor set and one or more computer-readable storage media. Program instructions are stored on the one or more computer-readable storage media to cause the processor set to perform operations. The operations include obtaining system diagnostic data corresponding to data events associated with an authorized system component of an operating system. The operations also include determining, based on the system diagnostic data, at least one parameter format associated with the authorized system component. The operations further include configuring a security test based on the at least one parameter format. The operations additionally include performing the security test in association with the authorized system component. This system has the technical effect of enabling more effective security testing of authorized system components without requiring detailed API documentation. Additionally, or alternatively, this system provides the technical advantage of automating the discovery and analysis of parameter formats for authorized services, reducing the manual effort required for security testing.

In embodiments, the obtaining of the system diagnostic data includes obtaining at least one of system dump data and system log entry data. This has the technical effect of providing comprehensive system state information for analysis. Additionally, or alternatively, using system dump and log data allows for non-intrusive data collection without impacting system performance.

In embodiments, the obtaining of the system diagnostic data includes obtaining system call traces including parameter data. This has the technical effect of providing detailed information about the interactions between the authorized system component and the operating system. Additionally, or alternatively, analyzing system call traces enables more accurate parameter format determination.

In embodiments, the obtaining of the system call traces includes obtaining call traces from a general trace facility (GTF). This has the technical effect of capturing a wide range of system events and activities. Additionally, or alternatively, using GTF allows for flexible and comprehensive tracing of system behavior.

In embodiments, the obtaining of the system call traces includes obtaining call traces from system log entry interface program (SLIP) traps. This has the technical effect of enabling targeted tracing of specific system conditions or error states. Additionally, or alternatively, using SLIP traps allows for efficient data collection with minimal impact on system performance.

In embodiments, the obtaining of the system diagnostic data includes obtaining system traces including register status information. This has the technical effect of providing low-level information about the system state during execution of the authorized component. Additionally, or alternatively, analyzing register status traces enables more precise determination of parameter usage and data flow.

In embodiments, the authorized system component includes at least one of an authorized service or an authorized program. This has the technical effect of enabling comprehensive security testing across different types of privileged system components. Additionally, or alternatively, this allows for a unified approach to testing both services and programs with elevated privileges.

In embodiments, the obtaining of the system diagnostic data includes observing a call via a trace facility, the call comprising at least one of a system call or a supervisor call and recording, at least one of register data passed in association with the call or parameter data passed in association with the call. This has the technical effect of capturing system behavior in response to specific triggers. Additionally, or alternatively, using supervisor calls allows for controlled and repeatable data collection.

In embodiments, the determining of the at least one parameter format associated with the authorized system component includes obtaining a set of values of a parameter associated with the authorized system component and classifying the parameter into one of a plurality of different parameter types based on the set of values. This has the technical effect of enabling automated analysis of parameter characteristics. Additionally, or alternatively, this classification approach allows for more targeted and effective security testing.

In embodiments, the classifying of the parameter into one of the plurality of different parameter types includes classifying the parameter as a constant value based on the set of values being constant. This has the technical effect of identifying fixed parameters that may be required for valid service calls. Additionally, or alternatively, recognizing constant values enables more efficient test case generation by reducing the parameter space to be explored.

In embodiments, the classifying of the parameter into one of the plurality of different parameter types includes classifying the parameter as a function code based on a variance in the set of values associated with a value range. This has the technical effect of identifying parameters that represent different operational modes or commands. Additionally, or alternatively, recognizing function codes allows for more comprehensive testing by exploring different functional paths within the authorized component.

In embodiments, the classifying of the parameter into one of the plurality of different parameter types includes classifying the parameter as a bit flag based on the set of values comprising a set of bit flag values. This has the technical effect of identifying parameters used to represent multiple boolean options. Additionally, or alternatively, recognizing bit flags enables more thorough testing by exploring different combinations of options.

In embodiments, the classifying of the parameter into one of the plurality of different parameter types includes classifying the parameter as a pointer based on a variance in the set of values and the set of values including pointer information. This has the technical effect of identifying parameters used to reference memory locations or data structures. Additionally, or alternatively, recognizing pointers enables more targeted security testing for vulnerabilities such as buffer overflows or use-after-free conditions.

According to an aspect of the disclosure, there is provided a computer-implemented method. The method includes obtaining system diagnostic data corresponding to data events associated with an authorized system component of an operating system. The method also includes determining, based on the system diagnostic data, at least one parameter format associated with the authorized system component. The method further includes configuring a security test based on the at least one parameter format. The method additionally includes performing the security test in association with the authorized service. This method has the technical effect of enabling dynamic discovery and analysis of parameter formats for authorized system components. Additionally, or alternatively, this method provides the technical advantage of improving the effectiveness and efficiency of security testing for privileged system components.

In embodiments, the determining of the at least one parameter format associated with the authorized system component includes obtaining a set of values of a parameter associated with the authorized system component and classifying the parameter into one of a plurality of different parameter types based on the set of values. This has the technical effect of enabling automated analysis of parameter characteristics. Additionally, or alternatively, this classification approach allows for more targeted and effective security testing.

In embodiments, the classifying of the parameter into one of the plurality of different parameter types includes classifying the parameter as a function code based on a variance in the set of values associated with a value range. This has the technical effect of identifying parameters that represent different operational modes or commands. Additionally, or alternatively, recognizing function codes allows for more comprehensive testing by exploring different functional paths within the authorized component.

In embodiments, the classifying of the parameter into one of the plurality of different parameter types includes classifying the parameter as a bit flag based on the set of values comprising a set of bit flag values. This has the technical effect of identifying parameters used to represent multiple boolean options. Additionally, or alternatively, recognizing bit flags enables more thorough testing by exploring different combinations of options.

According to an aspect of the disclosure, there is provided a computer program product. The computer program product includes one or more computer-readable storage media and program instructions stored on the one or more computer-readable storage media to perform operations. The operations include obtaining system diagnostic data corresponding to data events associated with an authorized system component of an operating system. The operations also include determining, based on the system diagnostic data, at least one parameter format associated with the authorized system component. The operations further include configuring a security test based on the at least one parameter format. The operations additionally include performing the security test in association with the authorized service. This computer program product has the technical effect of enabling automated discovery and analysis of parameter formats for authorized system components. Additionally, or alternatively, this computer program product provides the technical advantage of improving the scalability and consistency of security testing for privileged system components across different environments.

In embodiments, the determining of the at least one parameter format associated with the authorized system component includes obtaining a set of values of a parameter associated with the authorized system component and classifying the parameter into one of a plurality of different parameter types based on the set of values. This has the technical effect of enabling automated analysis of parameter characteristics. Additionally, or alternatively, this classification approach allows for more targeted and effective security testing.

In embodiments, the obtaining of the system diagnostic data includes obtaining at least one of system dump data and system log entry data. This has the technical effect of providing comprehensive system state information for analysis. Additionally, or alternatively, using system dump and log data allows for non-intrusive data collection without impacting system performance.

Additionally or alternatively, an embodiment in which obtaining the system diagnostic data includes obtaining system call traces from a general trace facility (GTF) and system log entry interface program (SLIP) traps has the technical effect of providing comprehensive and targeted tracing of system behavior. This combination enables both broad capture of system events through GTF and precise monitoring of specific conditions using SLIP traps. The technical advantage of this approach is improved efficiency in data collection, as it allows for flexible and thorough tracing while minimizing impact on system performance.

Additionally or alternatively, an embodiment in which the authorized system component comprises at least one of an authorized service or an authorized program, and the obtaining of the system diagnostic data includes initiating a system call via a supervisor call and recording the system diagnostic data in response to the system call, has the technical effect of enabling controlled and repeatable data collection for privileged system components. This combination allows for targeted testing of specific authorized services or programs while capturing detailed diagnostic information triggered by supervisor calls. The technical advantage of this approach is improved accuracy and reproducibility in security testing, as it provides a consistent method for invoking and analyzing the behavior of authorized system components.

Additionally or alternatively, an embodiment in which determining the at least one parameter format includes obtaining a set of values of a parameter associated with the authorized system component, classifying the parameter into one of a plurality of different parameter types based on the set of values, and where the classifying includes identifying the parameter as a constant value, function code, bit flag, or pointer, has the technical effect of enabling comprehensive and automated analysis of parameter characteristics. This combination allows for precise categorization of parameters, facilitating more targeted and effective security testing. The technical advantage of this approach is improved efficiency in test case generation, as it enables the testing framework to tailor its strategies based on the specific types of parameters identified, potentially uncovering vulnerabilities that might be missed by less sophisticated testing methods.

Various implementations can be applied to enhance security testing of authorized services in mainframe environments. For example, consider an authorized service that manages user authentication within a banking system running on a mainframe operating system. Using the dynamic parameter discovery method described herein, a security tester could first obtain system diagnostic data by monitoring system calls related to login attempts using the General Trace Facility (GTF) and System Log Interface Program (SLIP) traps. By analyzing this trace data, the system could determine that the authentication service accepts parameters for username (a string), password (a string), and authentication method (an integer flag). Based on this discovered parameter format, the security testing tool could configure tests that include valid and invalid usernames of various lengths, password strings with special characters, and different authentication method flags. During testing, the tool might discover that certain long username inputs cause unexpected behavior, potentially indicating a buffer overflow vulnerability in the authorized service.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer system comprising:
a processor set;
one or more computer-readable storage media; and
program instructions stored on the one or more computer-readable storage media to cause the processor set to perform operations comprising:
obtaining system diagnostic data corresponding to data events associated with an authorized system component of an operating system;
determining, based on the system diagnostic data, at least one parameter format associated with the authorized system component;
configuring a security test based on the at least one parameter format; and
performing the security test in association with the authorized system component.

2. The computer system of claim 1, wherein the obtaining the system diagnostic data comprises obtaining at least one of system dump data and system log entry data.

3. The computer system of claim 1, wherein the obtaining the system diagnostic data comprises obtaining system call traces including parameter data.

4. The computer system of claim 3, wherein the obtaining the system call traces comprises obtaining call traces from a general trace facility (GTF).

5. The computer system of claim 3, wherein the obtaining the system call traces comprises obtaining call traces from system log entry interface program (SLIP) traps.

6. The computer system of claim 1, wherein the obtaining the system diagnostic data comprises obtaining system traces including register status information.

7. The computer system of claim 1, wherein the authorized system component comprises at least one of an authorized service or an authorized program.

8. The computer system of claim 1, wherein the obtaining the system diagnostic data comprises:
observing a call via a trace facility, the call comprising at least one of a system call or a supervisor call; and
recording, at least one of register data passed in association with the call or parameter data passed in association with the call.

9. The computer system of claim 1, wherein the determining the at least one parameter format associated with the authorized system component comprises:
obtaining a set of values of a parameter associated with the authorized system component; and
classifying the parameter into one of a plurality of different parameter types based on the set of values.

10. The computer system of claim 9, wherein the classifying the parameter into one of the plurality of different parameter types comprises:
classifying the parameter as a constant value based on the set of values being constant.

11. The computer system of claim 9, wherein the classifying the parameter into one of the plurality of different parameter types comprises:
classifying the parameter as a function code based on a variance in the set of values associated with a value range.

12. The computer system of claim 9, wherein the classifying the parameter into one of the plurality of different parameter types comprises:
classifying the parameter as a bit flag based on the set of values comprising a set of bit flag values.

13. The computer system of claim 9, wherein the classifying the parameter into one of the plurality of different parameter types comprises:
classifying the parameter as a pointer based on a variance in the set of values and the set of values including pointer information.

14. A computer-implemented method comprising:
obtaining system diagnostic data corresponding to data events associated with an authorized system component of an operating system;
determining, based on the system diagnostic data, at least one parameter format associated with the authorized system component;
configuring a security test based on the at least one parameter format; and
performing the security test in association with the authorized system component.

15. The computer-implemented method of claim 14, wherein the determining the at least one parameter format associated with the authorized system component comprises:
obtaining a set of values of a parameter associated with the authorized system component; and
classifying the parameter into one of a plurality of different parameter types based on the set of values.

16. The computer-implemented method of claim 15, wherein the classifying the parameter into one of the plurality of different parameter types comprises:
classifying the parameter as a function code based on a variance in the set of values associated with a value range.

17. The computer-implemented method of claim 15, wherein the classifying the parameter into one of the plurality of different parameter types comprises:
classifying the parameter as a bit flag based on the set of values comprising a set of bit flag values.

18. A computer program product comprising:
one or more computer-readable storage media; and
program instructions stored on the one or more computer-readable storage media to perform operations comprising:
obtaining system diagnostic data corresponding to data events associated with an authorized system component of an operating system;
determining, based on the system diagnostic data, at least one parameter format associated with the authorized system component;
configuring a security test based on the at least one parameter format; and
performing the security test in association with the authorized system component.

19. The computer program product of claim 18, wherein the determining the at least one parameter format associated with the authorized system component comprises:
obtaining a set of values of a parameter associated with the authorized system component; and
classifying the parameter into one of a plurality of different parameter types based on the set of values.

20. The computer program product of claim 18, wherein the obtaining the system diagnostic data comprises:
obtaining at least one of system dump data and system log entry data.
